(19) United States
(12) Patent Application Publication
(10) Pub. No.: US 2001/0037984 A1
(43) Pub. Date: Nov. 8, 2001

(54) Method for the separation of impurities in incoming wastewater and a device for applying the method

(76) Inventor: Olle Tornegard, Kalmar (SE)

Correspondence Address: Sten Tornegard, 1037 Countess Dr., Yardley, PA, 19067, US

(21) Appl. No.: 09/756,252

(22) Filed: Jan. 8, 2001

(30) Foreign Application Priority Data
May 8, 2000 (SE) PCT/SE00/00909

(51) Int. Cl. B01D 21/24

(52) U.S. Cl. 210/803

(57) ABSTRACT

This invention relates to a method and a device for the separation of impurities in incoming wastewater. The method according to the invention is characterized in that wastewater containing impurities in the form of sand, gravel, stone, paper or similar material from water toilets or the like is led into a close channel (1) or the like, heavier material via an intake (3) being separated and fed with a spiral conveyor (4), which leads the material by means of a driving device (5) for the dewatering and emptying via an outlet (6) in a suitable place, while lighter material is provided with the liquid water to strainer means (10, 11), air owing to different weight of lighter material being supplied by means of a device (9), which is placed, if necessary, on an adjustable device (8), easier material being stuck on the strainer means (10, 11), where strainer means (10) is arranged solid and strainer means (11) movable, the movable strainer means (11) being driven with a driving means (13) for the leading of cleaning material down into a spiral conveyor (12) for further dewatering and transportation of the material to a suitable landfill place.

### CROSS-REFERENCE TO RELATED APPLICATIONS

An international patent application (International Application Number: PCT/SE00/00909) for this invention has been filed on May 8, 2000.

### BACKGROUND OF THE INVENTION

This invention relates to a method for the separation of impurities in incoming wastewater and a device for applying the method.

In the technique in question there are before known various types of strainer means for the separation of solid particles from wastewater. The Swedish Patent 458.862 shows generally a grating for the separation and transportation of material from polluted fluid. The primary with said technique is that cleaning material is lifted up with gravel, sand and paper to a screw-device or the like for the transportation to storage, as it has been mentioned in the Swedish Patent 468.095.

### BRIEF SUMMARY OF THE INVENTION

The purpose of this invention is to bring about that coming cleaning material from pumping stations having piping of polyethylene is liberated from wear and tear and stuffing up with gravel and rags, stockings or similar material, free current pumps can be utilized with cheaper working costs and descending function gives from hazardous point of view an emptying free from smell of the cleaning material, when it happens during the water surface.

The method and the device according to the invention are characterized by what is evident from the patent claims attached.

### BRIEF DESCRIPTION OF THE DRAWINGS

FIG. 1 is a side elevation showing incoming wastewater flowing from left to right, and being filtered by the device.

FIG. 2 is a cross section of FIG. 1.

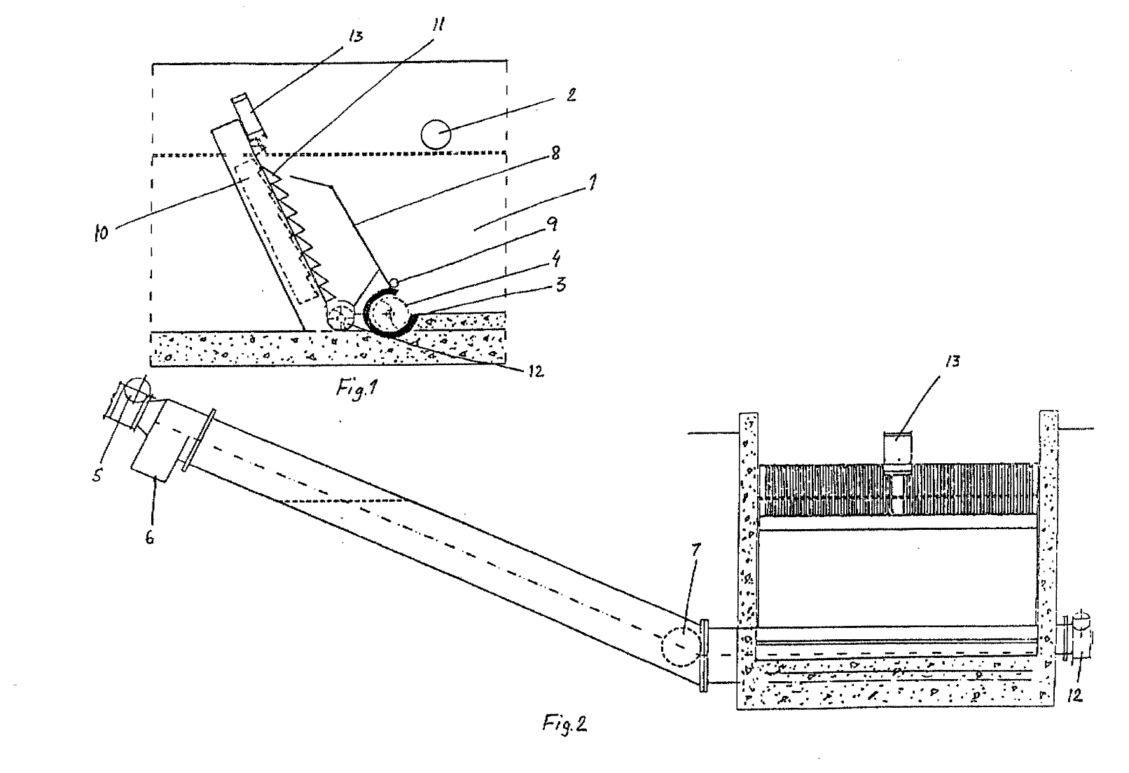

### DETAILED DESCRIPTION

Wastewater containing impurities from water closet or the like is led into a closed channel 1 or the like which is provided with an edge sewage 2, which is arranged for overcapacity. The heavier material in the form of gravel, sand, stone or the like is led in via an intake 3 and is separated and is fed with a spiral conveyor 4, which is provided with a ball-hinge and which removes the material by means a driving device 5 for the de-watering and emptying via an outlet 6 in a suitable place. The lighter material in the form of paper or the like flows with the water, and as this material can have different weight for the transfer to strainer means 10 and 11, air can be supplied by means of a device 9, which is placed, if necessary, on a regulating, vertically adjustable device 8. The transferred wastewater, which now is clean from heavier particles, consists of light particles and these stick on the strainer means 10 and 11. The strainer means consist of a solid 10 and movable 11 means containing divided rods. The solid strainer means 10 or the grating is provided with a toothed surface having discharging downwards, while the movable strainer means 11 or the grating is arranged with barbs, which are precipitated at descent for the transportation and are let in at ascent, when the solid strainer means 10 has taken over the straining. The movable strainer means 11 or the grating is driven by a driving means 13 and leads the cleaning material down into a spiral conveyor 12, which has a certain press effect for the separation of water and which removes the material during de-watering to a suitable landfill place, as e.g. a container or the like.

The invention is of course not limited to this design but can of course being varied within the scope of the invention idea.

I claim:

1. A method for the separation of impurities in incoming wastewater, characterized in that wastewater containing impurities in the form of sand, gravel, stone, paper or similar material from water toilets or the like is led into a close channel (1) or the like, heavier material via an intake (3) being separated and fed with a spiral conveyor (4) which leads the material by means of a driving device (5) for the de-watering and emptying via an outlet (6) in a suitable place, while lighter material is provided with the liquid water to strainer means (10, 11), air owing to different weight or lighter material being supplied by means of a device (9), which is placed, if necessary, on an adjustable device (8), lighter material being stuck on the strainer means (10, 11), where strainer means (10) is arranged solid and strainer means (11) movable, the movable strainer means (11) being driven with a driving means (13) for the leading of cleaning material down into a spiral conveyor (12) for further de-watering and transportation of the material to a suitable landfill place.

2. A device according to claim 1 for the separation of impurities in incoming wastewater, characterized in that it is arranged with a close channel (1), which is arranged for incoming water and is provided with an edge sewage (2), heavier material via an intake (3) being separated and fed with a spiral conveyor (4), which is provided with a ball-hinge (7), to the transportation of material by means of a driving means (5) for the de-watering and emptying via a outlet (6) in a suitable place, and lighter material is led with liquid water to strainer means (10, 11), air owing to different weight of lighter material being supplied by means of a device (9), which is placed, if necessary, on a regulating, vertically adjustable device (8), lighter material being arranged to stick on strainer means (10, 11), where the strainer means (10) is arranged solid with a toothed surface having discharging downwards and the strainer means (11) is arranged movable and provided with barbs, which are precipitated at descent for the transportation and are let in at ascent, when the solid strainer means (10) has taken over the straining, the movable strainer means (11) being driven by a driving means (13) for the leading of cleaning material down into a spiral conveyor (12) for further de-watering and transportation of the material to a suitable place, as e.g. a container or the like.
